(19) United States
(12) Patent Application Publication
(10) Pub. No.: US 2003/0111958 A1
(43) Pub. Date: Jun. 19, 2003

(54) Single ended discharge light source

(76) Inventors: Holger Claus, Lake Forest, CA (US); Randal S. Kincade, Irvine, CA (US); Alexandra Anghelus, Buena Park, CA (US)

Correspondence Address: COUDERT BROTHERS LLP, 333 SOUTH HOPE STREET, 23RD FLOOR, LOS ANGELES, CA, 90071, US

(21) Appl. No.: 10/017,285

(22) Filed: Dec. 13, 2001

(51) Int. Cl. H01J 17/18; H01J 61/36

(52) U.S. Cl. 313/625

(57) ABSTRACT

The present invention provides a method and apparatus for a single ended discharge light source. In one embodiment, both leads of a discharge lamp enter from the same side of the lamp. In one embodiment, the leads pass through a base. A bulb is positioned over the base to form a lamp wherein both leads enter the lamp from the same end. In one embodiment, the base is made of glass. In another embodiment, the bulb is made of glass. In one embodiment, the thermal expansion coefficient of the bulb and the base are greater than 1.0*10ˆ -6/K. In another embodiment, the thermal expansion properties of the material used for the leads closely matches the material used for the base. In one embodiment, the power of the discharge lamp is less than 50 watts. In another embodiment, the end of the bulb furthest from the base is a lens.

### BACKGROUND OF THE INVENTION

1. Field of the Invention

The present invention relates to the field of light sources, and in particular to a method and apparatus for a single ended discharge light source.

2. Background Art

In a typical discharge lamp, light is emitted from an electrical discharge across a gap between two electrodes. The leads to the electrodes enter the discharge lamp usually from opposite ends. In some applications for light sources, it is undesirable to have the leads of the light source enter the light source from opposite ends of the light source. This problem can be better understood with a review of discharge lamps.

Discharge Lamps

In a discharge lamp, a gas is enclosed in a transparent tube or formed bulb, and a voltage is applied across two electrodes. A discharge arc between the electrodes through the gas produces light. FIG. 1 illustrates a traditional discharge lamp. Two leads 100 enter a bulb 110 from opposite ends. Typically, the bulb is made from quartz, which limits the material used for the leads to molybdenum. Both leads typically pass through a stem 120 to enter the bulb. Once the leads are in position in the bulb, the stem is sealed. In a DC discharge lamp, a cathode 130 attaches to one lead and an anode 140 attaches to the other lead.

A gas, typically xenon at a high pressure, fills the bulb through a pumping stem. Once the gas is in the bulb, the pumping stem is clipped off by a process that seals the bulb where the pumping stem is removed. However, the process leaves an imperfection 150 in the bulb surface which typically decreases light's ability to pass through that section of the bulb. Once the bulb is sealed, a voltage is applied across the cathode and anode. The resulting discharge between the electrodes produces light. Typically, high pressure xenon discharge lamps are DC lamps in the range of 50 watts to 8000 watts.

Disadvantages Associated with Prior Art Low Wattage Discharge Lamps

For lamps with less than 50 watts, it becomes very difficult to fill and seal the lamps. Additionally, the arc gap is shortened, which increases the difficulty of properly aligning the electrodes. Additionally, the stems for the leads in traditional discharge lamps result in a bulky discharge lamp assembly which is unacceptable in applications where a compact lamp assembly is required (e.g., a flashlight). Additionally, the stems block the light produced in the bulb from traveling in some directions.

If the traditional discharge light is used with a reflector, either one lead and stem would block the light and produce a dark spot in the center of the light coming from the reflector or both leads and stems would block light from reaching the reflector and reduce the efficiency of the lamp. The distortion from the seal of the pumping stem also blocks light and reduces the efficiency of the lamp.

### SUMMARY OF THE INVENTION

The present invention provides a method and apparatus for a single ended discharge light source. In one embodiment, both leads of a discharge lamp enter from the same side of the lamp. Thus, the discharge lamp is less bulky than traditional discharge lamps. In one embodiment, the leads pass through a base. A bulb is positioned over the base to form a lamp wherein both leads enter the lamp from the same end. In one embodiment, the discharge lamp is sealed by melting the base to the bulb.

In one embodiment, the base is made of glass. In another embodiment, the bulb is made of glass. In one embodiment, the thermal expansion coefficient of the bulb and the base are greater than 1.0*10ˆ -6/K. In another embodiment, the thermal expansion properties of the material used for the leads closely matches the material used for the base. In one embodiment, the power of the discharge lamp is less than 50 watts.

In one embodiment, tungsten electrodes are attached to the leads inside the discharge lamp. In another embodiment, the electrodes are spot welded to the leads. A conducting material with a higher melting point than the operating temperature of the discharge lamp and a lower melting point than the melting point of the leads and electrodes is used as a weld agent to attach the electrodes to the leads. In one embodiment, platinum is used as a weld agent to attach the tungsten electrodes to the molybdenum leads. In another embodiment, tantalum is used as a weld agent to attach the tungsten electrodes to the molybdenum leads.

The tantalum also functions as a getter which cleans the fill gas. In another embodiment, a getter made of titanium is used in the discharge lamp. In yet another embodiment, a getter made of zirconium is used in the discharge lamp.

In one embodiment, the length of the gap between electrodes is less than 80% of the inner diameter of the bulb. In another embodiment, the length of the gap between electrodes is less than 75% of the inner length of the bulb. In one embodiment, the gap between the electrodes is parallel to the leads. In another embodiment, the gap between the electrodes is perpendicular to the leads.

In one embodiment, a brace is placed between the leads of the lamp. In one embodiment, the leads are braced by a conducting material positioned between the leads between the base and the electrodes. The brace maintains the leads' positions and the length of the gap during manufacture of the discharge lamp. The brace is melted in a final step of the manufacturing process and, thus, leaves a non-conducting path between the leads. The brace can be melted by applying a very high current to the leads. Other embodiments melt the conducting brace using other methods.

In one embodiment, the discharge lamp operates on AC current. In another embodiment, the discharge lamp operates on DC current. One electrode is a cathode and the other electrode is an anode.

In one embodiment, the gas in the bulb is xenon. In another embodiment, the xenon gas is at a pressure of more than one bar. In one embodiment, the gas is positioned in the lamp without using a pumping stem. Thus, there is no distorted area on the bulb where a pumping stem is clipped off. In one embodiment, the bulb is sealed to the base by heating the bulb and base under very high pressure to a temperature high enough to soften the base and bulb. The pressure during heating exceeds the final fill pressure of the lamp.

In another embodiment, the end of the bulb furthest from the base is a lens. The lens redirects the light coming through that portion of the discharge lamp and can focus the light to a point.

### BRIEF DESCRIPTION OF THE DRAWINGS

These and other features, aspects and advantages of the present invention will become better understood with regard to the following description, appended claims and accompanying drawings where:

FIG. 1 is a block diagram of a traditional discharge lamp.

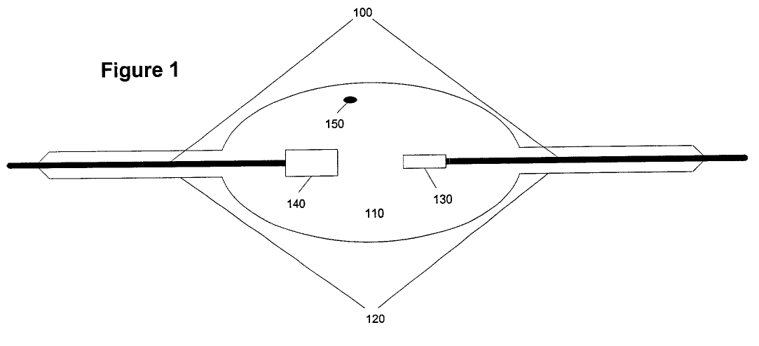

FIG. 2 is a block diagram of a single ended discharge lamp in accordance with one embodiment of the present invention.

FIG. 3 is a flow diagram of the process of making a single ended discharge light source in accordance with one embodiment of the embodiment.

FIG. 4 is a block diagram of a single ended discharge light source with a gap between electrodes that is parallel to the leads in accordance with one embodiment of the invention.

FIG. 5 is a block diagram of a single ended discharge light source with a gap between electrodes that is perpendicular to the leads in accordance with one embodiment of the invention.

FIG. 6 is a block diagram of a single ended discharge light source with a brace between the leads in accordance with one embodiment of the invention.

FIG. 7 is a lock diagram of a single ended discharge lamp with a lens at the end of the bulb in accordance with one embodiment of the present invention.

### DETAILED DESCRIPTION OF THE INVENTION

Embodiments of the invention are directed towards a single ended discharge light source. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Single Ended Discharge Light Source

In one embodiment, both leads of a discharge lamp enter from the same side of the lamp. Thus, the discharge lamp is less bulky than traditional discharge lamps. In one embodiment, the leads pass through a base. A bulb is positioned over the leads with the base at the end of the bulb. In one embodiment, the discharge lamp is sealed by melting the base to the bulb.

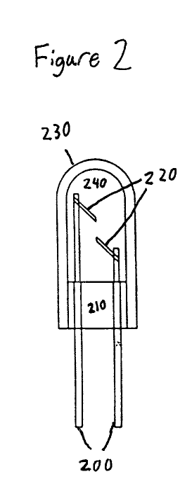

FIG. 2 illustrates a single ended discharge lamp in accordance with one embodiment of the present invention. Two leads 200 pass through the base 210. An electrode 220 is attached to each lead. A bulb 230 is positioned over the electrodes with the base at the end of the bulb. The bulb and the base are sealed together in an airtight manner. Additionally, the base forms an airtight seal around the leads. Thus, the gas 240 in the discharge lamp is prevented from leaking out of the lamp. In one embodiment, the gas is xenon at more than one bar of pressure. In other embodiments, other gases and/or other pressure levels are used.

Glass Base and Bulb

In one embodiment, the base is made of glass. In another embodiment, the bulb is made of glass. The types of glass used in the bulb and base is selected to insure that the thermal expansion coefficients of the bulb and glass are similar. If the thermal expansion coefficients were dissimilar, defects would form in the seal as base and bulb cool after they are melted together to form the seal. In one embodiment, the thermal expansion coefficient of the bulb and the base are greater than 1.0*10ˆ -6/K. In another embodiment, the thermal expansion properties of the material used for the leads closely matches the material used for the base. Thus, differences in thermal expansion coefficients will not cause the seal around the lead to be defective. In one embodiment, the power of the discharge lamp is less than 50 watts.

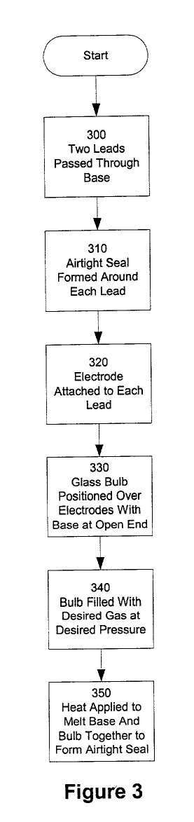

FIG. 3 illustrates the process of making a single ended discharge light source in accordance with one embodiment of the embodiment. At step 300, two leads are passed through a base. At step 310, an airtight seal is formed around each lead. At step 320, an electrode is attached to each lead. At step 330, a glass bulb is positioned over the electrodes with the base at the open end. At step 340, the bulb is filled with the desired gas at the desired pressure. In one embodiment, the gas is xenon and the pressure is greater than one bar. Other embodiments use other gasses and/or other pressure levels. At step 350, heat is applied to melt the base and bulb together to form an airtight seal.

Electrodes

In one embodiment, tungsten electrodes are attached to the leads inside the discharge lamp. In another embodiment, the electrodes are spot welded to the leads. A conducting material with a higher melting point than the operating temperature of the discharge lamp and a lower melting point than the melting point of the leads and electrodes is used as a weld agent to attach the electrodes to the leads. In one embodiment, platinum is used as a weld agent to attach the tungsten electrodes to the molybdenum leads. In another embodiment, tantalum is used as a weld agent to attach the tungsten electrodes to the molybdenum leads.

The tantalum also functions as a getter which cleans the fill gas. In another embodiment, a getter made of titanium is used in the discharge lamp. In one embodiment, a getter comprised of a short piece of titanium is attached to one of the leads. In yet another embodiment, a getter made of zirconium is used in the discharge lamp.

In one embodiment, the length of the gap between electrodes is less than 80% of the inner diameter of the bulb. In another embodiment, the length of the gap between electrodes is less than 75% of the inner length of the bulb. In one embodiment, the gap between the electrodes is parallel to the leads.

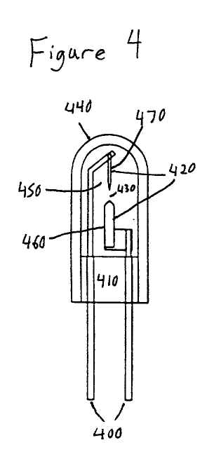

FIG. 4 illustrates a single ended discharge light source with a gap between electrodes that is parallel to the leads in accordance with one embodiment of the invention. Two leads 400 pass through the base 410. An electrode 420 is attached to each lead. The electrodes are positioned so that the gap 430 between the electrodes is parallel to the leads. A bulb 440 is positioned over the electrodes with the base at the end of the bulb. The bulb and the base are sealed together in an airtight manner. Additionally, the base forms an airtight seal around the leads. Thus, the gas 450 in the discharge lamp is prevented from leaking out of the lamp.

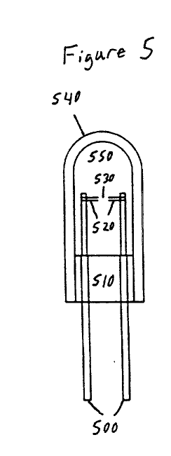

In another embodiment, the gap between the electrodes is perpendicular to the leads. FIG. 5 illustrates a single ended discharge light source with a gap between electrodes that is perpendicular to the leads in accordance with one embodiment of the invention. Two leads 500 pass through the base 510. An electrode 520 is attached to each lead. The electrodes are positioned so that the gap 530 between the electrodes is perpendicular to the leads. A bulb 540 is positioned over the electrodes with the base at the end of the bulb. The bulb and the base are sealed together in an airtight manner. Additionally, the base forms an airtight seal around the leads. Thus, the gas 550 in the discharge lamp is prevented from leaking out of the lamp.

Lead Brace

In one embodiment, a brace is placed between the leads of the lamp. In one embodiment, the leads are braced by a conducting material positioned between the leads between the base and the leads. The brace maintains the leads position and the length of the gap during manufacture of the discharge lamp. The brace is melted in a final step of the manufacturing process and, thus, leaves a non-conducting path between the leads. The brace can be melted by applying a very high current to the leads. Other embodiments melt the conducting brace using other methods. In one embodiment, a portion of the brace is a getter that cleans the gas of the discharge lamp.

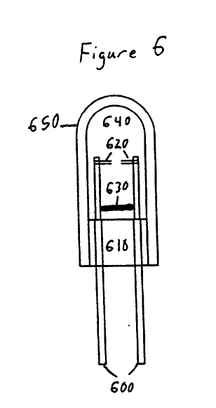

FIG. 6 illustrates a single ended discharge light source with a brace between the leads in accordance with one embodiment of the invention. Two leads 600 pass through the base 610. An electrode 620 is attached to each lead. A brace 630 made of conducting material is attached to the two leads between the base and the electrodes. The brace helps to maintain the position of the leads and electrodes during the sealing process.

Additionally, in one embodiment the brace has a portion made of a material that causes the brace to serve as a getter and clean the gas 640 of the discharge lamp. A bulb 650 is positioned over the electrodes with the base at the end of the bulb. The bulb and the base are sealed together in an airtight manner. Additionally, the base forms an airtight seal around the leads. Thus, the gas in the discharge lamp is prevented from leaking out of the lamp. After the lamp is sealed, a high current is applied to the leads and brace. The current melts the brace, which opens the electrical connection between the leads.

Current

In one embodiment, the discharge lamp operates on AC current. The discharge lamps of FIGS. 2, 5 and 6 operate on AC current. The electrodes of an AC lamp are similar, and typically AC lamps have a lower cost. In another embodiment, the discharge lamp operates on DC current. One electrode is a cathode and the other electrode is an anode. The discharge lamp of FIG. 4 operates on DC current. The anode 460 is connected to the positive side of the power supply and the cathode 470 is connected to the negative side of the power supply. Typically, a DC lamp has higher arc stability and lower power supply cost.

Gas

In one embodiment, the gas in the bulb is xenon. In another embodiment, the xenon gas is at a pressure of more than one bar. In other embodiments, other gasses and/or other pressure levels are used. In one embodiment, the gas is positioned in the lamp without using a pumping stem. Thus, there is no distorted area on the bulb where a pumping stem is clipped off.

In one embodiment, the bulb is sealed to the base by heating the bulb and base under very high pressure to a temperature high enough to soften the base and bulb. The pressure during heating exceeds the final fill pressure of the lamp. In one embodiment, the heating and sealing occurs inside a chamber of a machine that is capable of filling the chamber with the desired fill gas (e.g., xenon) at the desired pressure (e.g., more than one bar) at the desired temperature (e.g., hot enough to soften the base and the bulb).

Lens

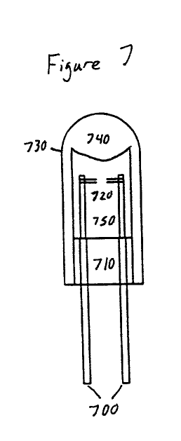

In another embodiment, the end of the bulb furthest from the base forms a lens. The lens redirects the light coming through that portion of the discharge lamp and can focus the light to a point. FIG. 7 illustrates a single ended discharge lamp with a lens at the end of the bulb in accordance with one embodiment of the present invention. Two leads 700 pass through the base 710. Electrodes 720 are attached to each lead. A bulb 730 is positioned over the electrodes with the base at the end of the bulb. The bulb has a lens 740 at the closed end. The bulb and the base are sealed together in an airtight manner. Additionally, the base forms an airtight seal around the leads. Thus, the gas 750 in the discharge lamp is prevented from leaking out of the lamp.

Thus, a method and apparatus for a single ended discharge light source is described in conjunction with one or more specific embodiments. The invention is defined by the following claims and their full scope and equivalents.

1. A method for assembling a discharge light source comprising:
positioning a first lead to enter said discharge light source from an end; and
positioning a second lead to enter said discharge light source from said end.

2. The method of claim 1 further comprising:
providing a base;
passing said first lead through said base wherein said base forms a first airtight seal around said first lead;
passing said second lead through said base wherein said base forms a second airtight seal around said second lead;
attaching a first electrode to said first lead;
attaching a second electrode to said second lead;
positioning a bulb wherein said base is encircled by an open end of said bulb and wherein said bulb and said base enclose said first and second electrodes;
filling said bulb with a gas; and
attaching said base to said bulb wherein said bulb forms a third airtight seal around said base.

3. The method of claim 2 wherein said base is made of glass.

4. The method of claim 2 wherein said bulb is made of glass.

5. The method of claim 2 wherein the thermal expansion coefficient of said base is greater than 1.0*10ˆ -6/K.

6. The method of claim 2 wherein the thermal expansion coefficient of said base is approximately equal to the thermal expansion coefficient of said bulb.

7. The method of claim 2 wherein the thermal expansion coefficients of said first lead and said second lead are approximately equal to the thermal expansion coefficient of said base.

8. The method of claim 2 wherein the power of said discharge light source is less than 50 watts.

9. The method of claim 2 wherein said first and second electrodes are made of tungsten.

10. The method of claim 2 wherein said step of attaching said first electrode to said first lead comprises:
spot welding said first electrode to said first lead.

11. The method of claim 10 wherein said step of spot welding comprises:
positioning a weld agent between said first electrode and said first lead; and
melting said weld agent.

12. The method of claim 11 wherein the melting point of said weld agent is higher than an operating temperature of said discharge light source and lower than the melting points of said first lead and said first electrode.

13. The method of claim 11 wherein said first electrode is made of tungsten and said first lead is made of molybdenum.

14. The method of claim 13 wherein said weld agent is made of platinum.

15. The method of claim 13 wherein said weld agent is made of tantalum.

16. The method of claim 2 further comprising:
cleaning said gas by positioning a getter inside said discharge light source.

17. The method of claim 16 wherein said getter is made of tantalum.

18. The method of claim 16 wherein said getter is made of titanium.

19. The method of claim 16 wherein said getter is made of zirconium.

20. The method of claim 2 wherein a gap between said first electrode and said second electrode is parallel to said first and second leads.

21. The method of claim 2 wherein a gap between said first electrode and said second electrode is perpendicular to said first and second leads.

22. The method of any one of claims 20 or 21 wherein the length of said gap is less than eighty percent of the inner diameter of said bulb.

23. The method of any one of claims 20 or 21 wherein the length of said gap is less than seventy-five percent of the inner length of said bulb.

24. The method of claim 2 further comprising:
positioning a brace wherein said brace attaches to said first lead between said first electrode and said base and wherein said brace attaches to said second lead between said second electrode and said base.

25. The method of claim 2 further comprising:
supplying an alternating current to said first and second leads.

26. The method of claim 2 further comprising:
supplying a direct current to said first and second leads.

27. The method of claim 2 wherein said gas is xenon.

28. The method of claim 2 wherein the pressure of said gas is greater than one bar.

29. The method of claim 2 wherein the closed end of said bulb is a lens.

30. A discharge light source comprising:
a first lead configured to enter said discharge light source from an end; and
a second lead configured to enter said discharge light source from said end.

31. The discharge light source of claim 30 further comprising:
a base wherein said first lead passes through said base wherein said base forms a first airtight seal around said first lead and wherein said second lead passes through said base wherein said base forms a second airtight seal around said second lead;
a first electrode wherein said first electrode is attached to said first lead;
a second electrode wherein said second electrode is attached to said second lead;
a bulb wherein said base is encircled by an open end of said bulb and wherein said bulb and said base enclose said first and second electrodes;
a gas wherein said gas is enclosed by said base and said bulb; and
an attaching mechanism configured to attach said base to said bulb wherein said bulb forms a third airtight seal around said base.

32. The discharge light source of claim 31 wherein said base is made of glass.

33. The discharge light source of claim 31 wherein said bulb is made of glass.

34. The discharge light source of claim 31 wherein the thermal expansion coefficient of said base is approximately equal to the thermal expansion coefficient of said bulb.

35. The discharge light source of claim 31 wherein the thermal expansion coefficient of said base is greater than 1.0*10ˆ -6/K.

36. The discharge light source of claim 31 wherein the thermal expansion coefficients of said first lead and said second lead are approximately equal to the thermal expansion coefficient of said base.

37. The discharge light source of claim 31 wherein the power of said discharge light source is less than 50 watts.

38. The discharge light source of claim 31 wherein said first and second electrodes are made of tungsten.

39. The discharge light source of claim 31 wherein said first electrode is spot welded to said first lead.

40. The discharge light source of claim 39 further comprising:
a weld agent positioned between said first electrode and said first lead wherein said weld agent is configured to hold said first electrode to said first lead after said weld agent is melted and allowed to cool.

41. The discharge light source of claim 40 wherein the melting point of said weld agent is higher than an operating temperature of said discharge light source and lower than the melting points of said first lead and said first electrode.

42. The discharge light source of claim 40 wherein said first electrode is made of tungsten and said first lead is made of molybdenum.

43. The discharge light source of claim 42 wherein said weld agent is made of platinum.

44. The discharge light source of claim 42 wherein said weld agent is made of tantalum.

45. The discharge light source of claim 31 further comprising:
a getter configured to clean said gas.

46. The discharge light source of claim 45 wherein said getter is made of tantalum.

47. The discharge light source of claim 45 wherein said getter is made of titanium.

48. The discharge light source of claim 45 wherein said getter is made of zirconium.

49. The discharge light source of claim 31 wherein a gap between said first electrode and said second electrode is parallel to said first and second leads.

50. The discharge light source of claim 31 wherein a gap between said first electrode and said second electrode is perpendicular to said first and second leads.

51. The discharge light source of any one of claims 49 or 50 wherein the length of said gap is less than eighty percent of the inner diameter of said bulb.

52. The discharge light source of any one of claims 49 or 50 wherein the length of said gap is less than seventy-five percent of the inner length of said bulb.

53. The discharge light source of claim 31 further comprising:
a brace configured to hold said first lead and said second lead in position wherein said brace attaches to said first lead between said first electrode and said base and wherein said brace attaches to said second lead between said second electrode and said base.

54. The discharge light source of claim 31 further comprising:
an alternating current wherein said current is supplied to said first and second leads.

55. The discharge light source of claim 31 further comprising:
a direct current wherein said current is supplied to said first and second leads.

56. The discharge light source of claim 31 wherein said gas is xenon.

57. The discharge light source of claim 31 wherein the pressure of said gas is greater than one bar.

58. The discharge light source of claim 31 wherein the closed end of said bulb is a lens.
